(19) United States
(12) Patent Application Publication
(10) Pub. No.: US 2003/0213257 A1
(43) Pub. Date: Nov. 20, 2003

(54) Apparatus and method for cooling occupants of a golf cart

(76) Inventor: Matthew La Madrid, San Diego, CA (US)

Correspondence Address: GARY L. EASTMAN, 707 BROADWAY STREET, SUITE 1800, SAN DIEGO, CA, 92101, US

(21) Appl. No.: 10/150,908

(22) Filed: May 16, 2002

(51) Int. Cl. B60H 1/32; F28D 5/00; B01F 3/04

(52) U.S. Cl. 62/244; 62/304; 62/306

(57) ABSTRACT

A golf cart cooling system includes a fluid reservoir, submersible fluid pump, distribution control valve, and misting nozzles. Fluid is pulled from the fluid reservoir through the submersible fluid pump and into the distribution control valve. The distribution control valve enables a golfer to control the misting to the right side, left side, or both sides of a golf cart. A golfer also has the ability to set the pressure of the mist by adjusting a pressure switch. The golf cart cooling system mounts on the rear end of the golf cart and has straps for two golf bags to be secured to the golf cart cooling system. The configuration of the golf cart cooling system provides enough fluid to cool the golfer for more than six hours without needing to be refilled.

### FIELD OF THE INVENTION

The present invention relates generally to golf cart accessories. More specifically, the present invention pertains to occupant cooling devices. The present invention is particularly, though not exclusively, useful for cooling the occupants with a misting system that is mounted on the rear of a golf cart.

### BACKGROUND OF THE INVENTION

Golf is a popular sport around the world, evidenced by the thousands of golf courses that spread across six of the seven continents. The scenery at most golf courses is spacious and beautiful. Various trees, such as an eucalyptus or oak trees, are spread out on the perimeter of golf courses. However, there is a need for wide-open fairways with little or no obstacles so that a golfer can have a clear path towards the pin. Climates also vary across the United States and the world resulting in a large range of temperatures. High temperatures in some areas are exacerbated by the direct sunlight that beats down on a golfer that is in the open fairway. In these areas of high temperatures, the need exists to create cooling systems that can turn the most scorching temperatures into a comfortable and enjoyable experience.

Presently, attempts have been made to create evaporation systems that cool the air around golfers. These evaporation systems shoot water out of misting nozzles to produce tiny molecules of water, or atomized water. Once these tiny molecules of water hit the air, the water molecules flash evaporate cooling the air. Under optimal conditions, such as dry dessert heat, the air can cooled as much as 25°-35° F. The misting process is even effective in conditions that are humid.

Examples of early portable evaporation systems include U.S. Pat. No. 6,367,278 (‘278 patent’) entitled “Portable Evaporative Cooling Apparatus,” which discloses an evaporation system utilizing a fan to propel the fluid. Other examples of fan-based evaporation systems are U.S. Pat. No. 6,325,362 and U.S. Pat. No. 6,182,463. The main disadvantages of these systems is that they blow water molecules on all occupants of the golf cart, the fan is bulky and noisy, and the water reservoir does not allow an entire days use. Both occupants must get colder or neither gets colder, which is not beneficial when one golfer is already comfortable. The second disadvantage of these systems is that the fan is bulky and takes up large amounts of space and energy. A golf cart has a limited amount of space, but the added space of an evaporation system with fan will create space issues for golfers. Golfers enjoy golfing for many reasons, such as the relaxation found when in an open area. If you decrease their space with these systems, the enjoyment that stems from playing golf goes down and the golfers will complain or choose not to rent a golf cart.

The next group of portable evaporation systems used compressed gas to pressurize the system. Included in this group is U.S. Pat. No. 6,151,907, U.S. Pat. No. 5,724,824, and U.S. Pat. No. 5,337,960. Using compressed gas to push water through a system results in a pulsating water flow. In the case of a golf cart evaporation system, mist will be ejected at an inconsistent rate that will be distracting to the golfers. Compressed gas also requires more effort for golfers if they have to pump a lever to compress the gas. Other systems use an air compressor to pressurize the system, which is very loud and would be even more distracting than the lever pump models.

A third type of evaporation system used on golf carts is U.S. Pat. No. 5,613,371. This model utilizes a pumping system with an accumulator and solenoid valve. An accumulator is used to trap air that pushes water (or other liquid) at a constant rate. Most accumulators are inflatable diaphragms and are prone to puncture or damage. Golf carts need to be durable because they do not have complex suspension systems and bounce around continuously. Therefore, an evaporation system must be durable. The accumulator system is very expensive and adds unnecessary complexity to an evaporation system.

In response to the above problems, there is a need for a golf cart evaporation system that will allow one occupant to be cooled while the other is unchanged by the system. Additionally, there is a need for an evaporation system that does not hinder the view and tranquility of a golfer. Finally, there is a need for a simple evaporation system that is inexpensive and durable.

Accordingly, it is an object of the present invention to provide a golf cart cooling system that allows the occupants to control the direction of mist that is ejected from the system. It is another object of the present invention to provide a golf cart cooling system that is silent and does not disturb the occupants or other golfers.

It is another object of the present invention to provide a golf cart cooling system that does not hinder the view of the occupants while sitting in the golf cart. It is yet another object of the present invention to provide a golf cart cooling system that uses inexpensive and durable components to decrease the cost of operating such a system.

### SUMMARY OF THE PRESENT INVENTION

The golf cart cooling system of the present invention includes a fluid reservoir having a fluid pump, inlet tube, and outlet tube within the fluid reservoir, golf bag straps, a power switch, a pressure switch, a distribution control switch that directs the flow of fluid though long tubes, and misting nozzles attached to the ends of the long tubes. Support brackets hold the fluid pump within the fluid reservoir, and the fluid pump has an inlet tube attached to the bottom and outlet tube attached to the top of the fluid pump.

The fluid reservoir is mounted on the rear of the golf cart where two golf bags usually are placed. Most golf carts also include a two-inch “lip” at the rear end of the golf bag area to ensure that the golf bags do not slide off of the cart. The fluid reservoir can be easily mounted in the golf bag area and held on to the golf cart by a fastener. For example, heavy duty Velcro could be place on the bottom of the fluid reservoir and on the floor of the golf bag area. A power cord would run from the fluid pump to one or more batteries that are already included in the design of the golf cart. It is also possible to have an alternative power source, such as a solar panel or more specialized battery packs.

When the power switch is turned on, fluid is pulled from the bottom of the fluid reservoir through the inlet tube and into the fluid pump. The fluid is then pushed out of the fluid pump and into the outlet tube with an adjustable amount of pressure. The level of pressure, measured in P.S.I. (pounds-per-square-inch), is determined when the occupant adjusts the pressure switch. The pressure switch allows a large range of pressure (approximately 15 P.S.I. to 100 P.S.I.). Next, the fluid passes through a distribution control valve, which is also set when the golfer adjusts the distribution control switch. The purpose of a distribution control valve is to direct the flow of fluid to the left side, right side, or both sides of the golf cart. Depending on which side the occupant desires the fluid to travel to, the fluid passes through the long tubes and is turned into a fine mist by a misting nozzle.

The power switch, pressure switch, and distribution control switch are all accessible to the golfer by being placed on the outside of the fluid reservoir. It should also be noted that the power switch, pressure switch, and distribution control switch can be placed on the dashboard of the golf cart for convenience. The golf cart cooling system, as disclosed, provides a golfer with more control over the amount of mist that is expelled from the mist nozzles. The golfer has the ability to control the distribution of mist so that only the golfer whom desires the mist gets cooler.

### DESCRIPTION OF THE DRAWINGS

The novel features of this invention, as well as the invention itself, both as to its structure and its operation, will be best understood from the accompanying drawings, taken in conjunction with the accompanying description, in which reference characters refer to similar parts, and in which:

FIG. 1 is perspective view of the Golf Cart Cooling System of the present invention;

FIG. 2 is a perspective view of the upper portion of the Golf Cart Cooling System of the present invention;

FIG. 3 is a front view of the distribution control switch, pressure switch, and power switch of the Golf Cart Cooling System of the present invention;

FIG. 4 is a perspective view of a golf cart with the Golf Cart Cooling System of the present invention mounted on the back of the golf cart;

FIG. 5 is a rear view of a golf cart with two golf bags secured to the Golf Cart Cooling System of the present invention; and

FIG. 6 is perspective view an alternative embodiment of the distribution control valve and distribution control switch.

### DETAILED DESCRIPTION OF A PREFERRED EMBODIMENT

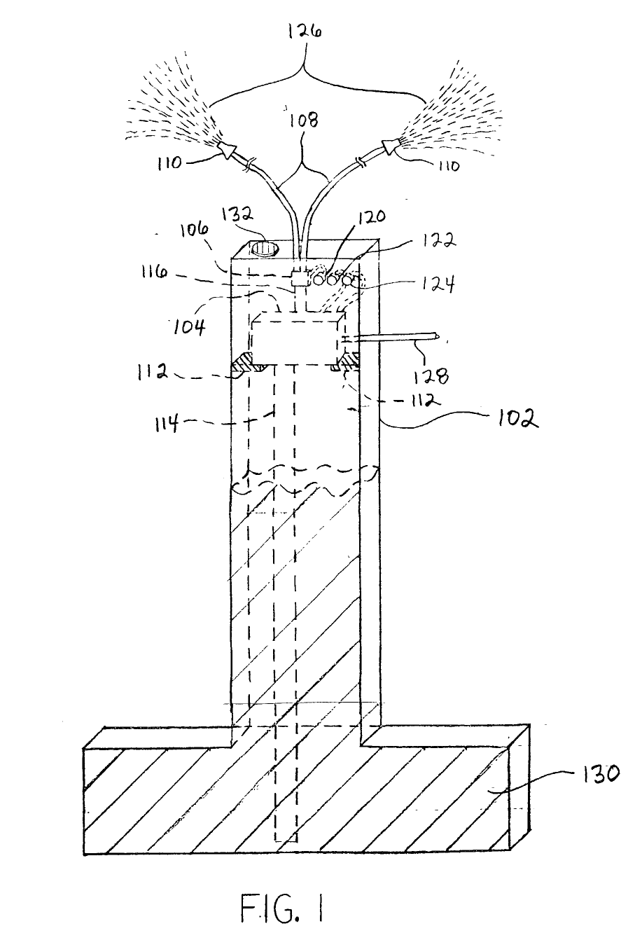

Referring initially to FIG. 1, the golf cart cooling system of the present invention is shown and generally designated 100. FIG. 1 is a perspective view of golf cart cooling system 100 and includes fluid reservoir 102 surrounding fluid pump 104 and distribution control valve 106. Golf cart cooling system 100 also includes extension tubes 108 and misting nozzles 110. Fluid pump 104 is held in place by support brackets 112, which are in turn attached to fluid reservoir 102. Fluid pump 104 also has inlet tube 114 attached to its underside and outlet tube 116 attached to its topside. Outlet tube 116 connects to the bottom of distribution control valve 106 and extension tubes 108 connect to the top of distribution control valve 106. Extension tubes 108 separate and extent until they connect to misting nozzles 110. Golf cart cooling system 100 further includes distribution control switch 120, pressure switch 122, and power switch 124. Distribution control switch 120 allows a golfer to control the flow of mist 126 to the right side, left side, or both sides of the golf cart. Pressure control switch 122 is also accessible to a golfer and enables a golfer to adjust the pressure of mist 126. Power switch 124 is a basic feature that controls the inflow of power from power cord 128 to fluid pump 104.

Golf cart cooling system 100 is filled with fluid 130 by removing fill cap 132 and placing a fluid hose into fluid reservoir 102. After fluid reservoir 102 is filled with a sufficient amount of fluid 130, the cooling system is ready. Power switch 124 is turned to the on position and fluid 130 is pulled from the bottom of fluid reservoir 102 through inlet tube 114 and into fluid pump 104. Fluid 130 is then pushed out of fluid pump 104 and into outlet tube 116. Next, fluid 130 passes through distribution control valve 106, is distributed to extension tubes 108, and is ejected from misting nozzles 110. Upon being ejected from misting nozzles 110, fluid 130 is separated into tiny molecules, also called atomized. The process of atomizing some fluids, such as water, results in flash evaporation and instantly cools the air temperature that surrounds mist 126. A golfer siting under mist 126 will experience cooler air contacting the skin.

In a preferred embodiment, fluid reservoir 102 may be composed of a strong, light-weight material that does not leak or rust when in contact with air, water, or other fluids, such as heavy plastic or other material known in the art. Fluid reservoir 102 should have no air or fluid leaks that could change the pressure inside fluid reservoir 102. Additionally, fluid reservoir 102 should have a base that fits into the golf bag area found in golf carts. Also, fluid reservoir 102 may have a large enough volume to enable continuous misting for an entire round of golf (18 holes), which can last up to six (6) hours. A preferred fluid pump 104 is submersible and is not susceptible to corrosion from contact with fluid that would be present inside of fluid reservoir 102. Fluid pump 104 should have sufficient pressure to push fluid out misting nozzles 110 with the level of pressure desired by a golfer. Distribution control valve 106 may be composed of plastic, rubber, any metal or other material known in the art that does not corroded and can regulate the distributional flow of fluid. It should also be noted that distribution control valve 106 may distribute the flow of fluid to two (2) or more extension tubes 108. Extension tubes 108, inlet tube 114, and outlet tube 116 may be composed of plastic, rubber, or other material known in the art that supplies fluid 130 and does not get corroded. Extension tubes 108 may vary in length depending on the desired location of misting nozzles 110. A preferred misting nozzle 110 may be composed of hard plastic, copper, brass, stainless steel, or any other material that is known in the art for being durable and not corroding when contacted by fluid 130. Support bracket 112 may be composed of hard plastic or metal that is known in the art for being strong, durable, and non-corrosive. Inlet tube 114 should be greater in diameter than outlet tube 116 and should reach to within about ¼ inch from the bottom of fluid reservoir 102.

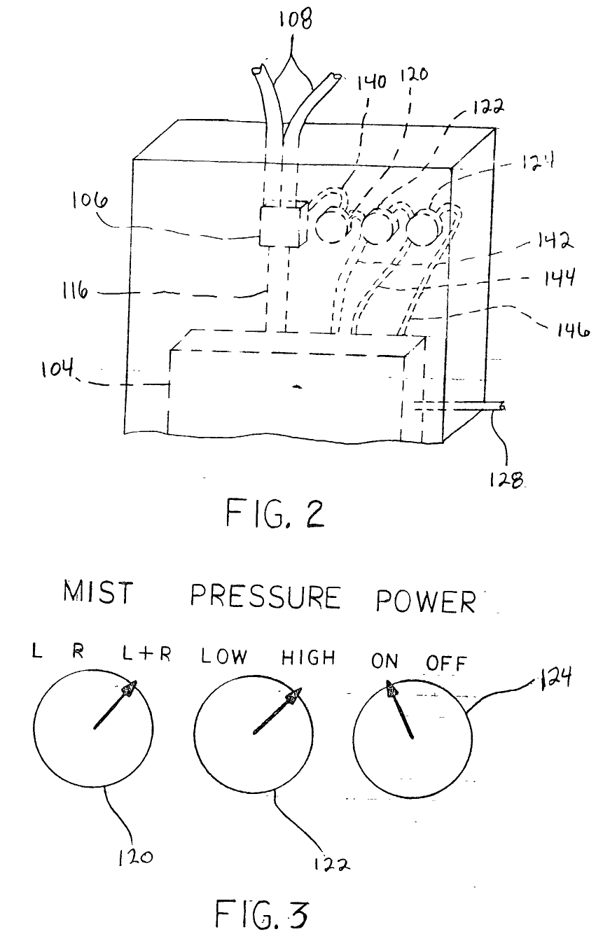

Turning to FIG. 2, a perspective view of the upper portion of golf cart cooling system 100. Distribution control switch cord 140 sends the signal of distribution control switch 120 to distribution control valve 106. Distribution control power cord 142 connects to a power supply located within fluid pump 104 and distribution control switch 120. Pressure switch cord 144 connects to fluid pump 104 and pressure switch 124 and allows adjustments in pressure switch 124 to change the pressure output of fluid pump 104. Power switch cord 146 connects power switch 124 to fluid pump 104 and enables commands to transfer.

In a preferred embodiment, distribution control switch 120, pressure switch 122, and power switch 124 may protrude from fluid reservoir 102 so that a golfer can easily adjust the switches as needed.

In an alternate embodiment, distribution control switch 120, pressure switch 122, and power switch 124 may also be placed on the dashboard for the convenience of the occupants. In such a case, distribution control switch cord 140, pressure switch cord 144, and power switch cord 146 would be extended to reach from fluid pump 104 to the dashboard.

FIG. 3 is a front view of the preferred embodiment of distribution control switch 120, pressure switch 122, and power switch 124. The switches are disc shaped and rotate to allow a golfer to control golf cart cooling system 100. It should be noted, however, that distribution control switch 120, pressure switch 122, and power switch 124 may be any shape or design that allows a golfer to adjust them to the desired setting.

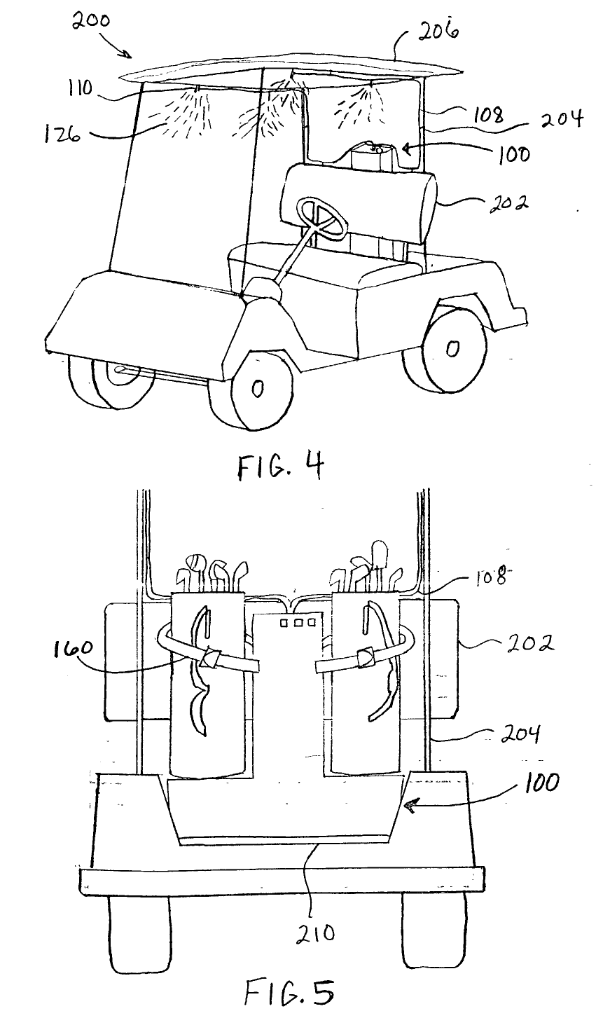

Looking at FIG. 4, a perspective view of golf cart 200 with the golf cart cooling system 100 mounted on the back of golf cart 200. Extension tubes 108 are also shown running along the top of seat 202, up rear roof support poles 204 and along the left and right sides of roof 206. Mist 126 is shown being ejected from four (4) misting nozzles 110.

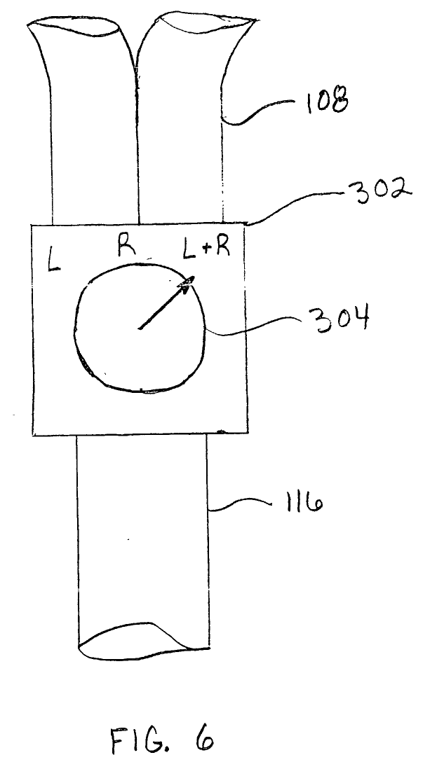

FIG. 5 is a rear view of golf cart 200 showing two golf bags secured to golf cart cooling system 100. Golf cart 200 has a lip 210 that gives golf cart cooling system 100 support from sliding off of the back of golf cart 200. Fluid reservoir 102 also has fasteners attached underneath between it and the rear bottom of golf cart 200. Two golf bags are placed on top of fluid reservoir 102 and are secured by two straps 160. Straps 160 are attached to fluid reservoir 102.

FIG. 6 is perspective view an alternative embodiment of distribution control valve 302 and distribution control switch 304. Distribution control switch 304 is integrally attached to distribution control valve 302 and mechanically changes the flow of fluid.

I claim:

1. A golf cart cooling system comprising:
a fluid reservoir;
a fluid pump;
a distribution control valve; and
at least two means to eject fluid;
wherein fluid is pulled from said fluid reservoir by said fluid pump and is pushed out said fluid pump and said means to eject the fluid, and said distribution control valve allows a user to control the flow of fluid to the left side, right side, or both sides of the golf cart.

2. The golf cart cooling system in claim 1, wherein said fluid reservoir has a fluid-cooling unit.

3. The golf cart cooling system in claim 2, wherein said fluid-cooling unit is a water cooler.

4. The golf cart cooling system in claim 1, wherein said fluid reservoir is surrounded by an insulating material.

5. The golf cart cooling system in claim 1, wherein said fluid reservoir attaches to the rear end of a golf cart by fasteners.

6. The golf cart cooling system in claim 1, wherein said fluid reservoir allows two golf bags to be placed on top of said fluid reservoir.

7. The golf cart cooling system in claim 6, wherein two golf bags are secured to said fluid reservoir by two straps attached to said fluid reservoir.

8. The golf cart cooling system in claim 1, wherein said fluid pump has a power switch that turns said fluid pump on and off.

9. The golf cart cooling system in claim 1, wherein a distribution control switch is attached to said distribution control valve and a user can adjust said distribution control switch to direct the fluid to the right side, left side, or both sides of the golf cart.

10. The golf cart cooling system in claim 1, wherein a pressure switch connects to said fluid pump and a user can change the amount of pressure that the fluid is being pushed by said fluid pump by adjusting said pressure switch.

11. The golf cart cooling system in claim 1, wherein said means to eject the fluid is a misting nozzle.

12. A golf cart cooling system comprising:
a fluid reservoir;
a submersible fluid pump with an inlet and outlet, and enclosed within said fluid reservoir;
an electrical power source connected to said submersible fluid pump;
at least one thick tube connected at first end to said inlet of said submersible fluid pump and second end making contact with fluid;
at least two thin tubes connected at first end to said outlet of said submersible fluid pump;
a distribution control valve; and
at least two means to eject the fluid.
wherein fluid is pulled from said fluid reservoir through said thick tube and said inlet by said submersible fluid pump and fluid is pushed out said outlet through said thin tube and said means to eject fluid, and said distribution control valve allows a user to distribute the flow of fluid to the left side, right side, or both sides of the golf cart.

13. A method for cooling persons inside of a golf cart comprising the steps of:
retaining fluid in a fluid reservoir on a golf cart;
pumping fluid from the fluid reservoir though means to eject fluid by a fluid pump;
powering the fluid pump by an electrical power supply; and
distributing the fluid either to the right side, left side, or both sides of the golf cart by a distribution control valve.

14. The method for cooling persons inside of a golf cart of claim 13, wherein the fluid pump can be turned on or off by the touch of a switch.

17. The method for cooling persons inside of a golf cart of claim 13, wherein the fluid pressure can be changed by the adjustment of a pressure switch attached to a fluid pump.
